(19) United States
(12) Patent Application Publication
(10) Pub. No.: US 2008/0233538 A1
(43) Pub. Date: Sep. 25, 2008

(54) TWO-PART SCREW FOR A DENTAL IMPLANT

(75) Inventors: Thomas Silvan Hug, Erlenbach (CH); David Egli, Basel (CH); Hans Schurch, Titterten (CH)

Correspondence Address: SCULLY SCOTT MURPHY & PRESSER, PC, 400 GARDEN CITY PLAZA, SUITE 300, GARDEN CITY, NY, 11530, US

(73) Assignee: STRAUMANN HOLDING AG, BASEL (CH)

(21) Appl. No.: 12/047,404

(22) Filed: Mar. 13, 2008

(30) Foreign Application Priority Data
Mar. 19, 2007 (EP) EPA 07104421.8

(51) Int. Cl. A61C 8/00

(52) U.S. Cl. 433/174

(57) ABSTRACT

A two-part screw for a dental implant with a screw rod and a nut, which is sized so as to be received into a screw passage channel of an abutment in an axially secured manner, and which is formed with an inner thread for screwing connection to a first coronal thread on the screw rod, the screw rod being furnished with a second apical thread, which is formed to screwingly connect the screw to the dental implant; the construction made up of screw rod and nut can be replaced with a screw with a screw bush.

The invention relates generally to a two-part screw for a dental implant with a simplified and secure fastening arrangement, which connects an abutment and a dental implant to one another in a form-fitting manner.

### BACKGROUND OF THE INVENTION

Dental prostheses with a dental implant inserted in the jaw and an abutment fastened thereon are well known as a tooth replacement. An abutment, which is preferably manufactured of ceramic, with plastic or polymer compounds also being possible, is connected in a frictional and form-fitting manner to the dental implant by means of a screw. The screw is preferably made of titanium, screws made of steel also being possible.

The insertion of the prosthesis, which is adapted to the tooth profile, in general takes place as soon as the implant inserted in the bone of the patient has healed in, and is performed by the doctor providing treatment. The dental laboratory supplies the required prosthesis components, which consist of the abutment with the tooth crown or bridge individually fabricated thereon and the (fastening) screw. To fix the abutment on the dental implant, the abutment is placed on the implant, and subsequently a screw is inserted through a cavity, which passes through the entire construction of abutment/implant, and then screwed into a thread of the dental implant. In this manner, the abutment and the dental implant are connected to one another in a form-fitting manner. The screw is in general tightened to a torque of more than 30 Nm. Due to the lack of space in the mouth and the dimensions of the tooth prosthesis, these screws must be formed relatively small so that there is space for them in a tooth crown.

The insertion of such a screw consequently requires a considerable skill on the part of the orthodontist, and can make treatment more difficult. It can thus happen that, during insertion, the screw slips out of the insertion tool and falls on the floor, so that either a new screw has to be used or the screw has to be time-consumingly sterilized, since the screw is subject to sterile conditions. In a worse case, if lost, the screw can also be swallowed by the patient during treatment. Moreover, the insertion of a single screw through the relatively narrow opening of the prosthesis requires a high level of concentration and skillfulness.

From EP 1 269 932 A, a dental implant with a conventional screw is known, a post and an intermediate piece connected thereto being rotationally fixedly fastened on a dental implant with the aid of such screw; since such screw is of one piece, however, the undesired effects cited above can occur.

### SUMMARY OF THE INVENTION

The present invention has the aim of providing a cost-effective two-part fastening screw for a dental implant with simplified and secure handling, which avoids the problems cited above.

Within this aim, a particular object of the present invention is to realize a two-part fastening screw for a dental implant, which allows preassembly by the manufacturer, the dental technician and/or the doctor. Moreover, according to the invention, the preassembly is also to be separable without difficulty in order to enable work on the abutment proper or to permit replacement in the case of damage to the screw.

A further object of the present invention is that the tooth structure provided with a two-part screw be easily directly insertable into the dental implant.

A further object of the present invention is to virtually preclude losing the screw during assembly.

The above aim and objects, which can be seen from the following description, are fulfilled by a two-part screw according to appended claim 1. Further advantageous embodiments of the present invention are the subject of the dependent claims.

According to a preferred embodiment of the present invention, the two-part screw comprises a nut and a screw rod.

The abutment can hence be supplied by the dental laboratory already preassembled, i.e. the screw rod can already be screwed at one end to the nut located in the screw passage channel. In such a preassembled condition the screw cannot be lost, as, on the one hand, the thread diameter of the screw rod is more largely dimensioned on the apical side than the screw passage channel of the abutment and, on the other hand, the head of the nut, which in the assembled condition is situated coronally, is arrested by an abutment inner edge, which has a smaller diameter in relation to the head of the nut. The nut is advantageously screwed to the coronal thread of the screw rod. Therefore, to connect the abutment to the dental implant, the portion of the screw rod projecting out of the abutment need only be inserted in the dental implant thread and screwed on. Awkward insertion of a nut and/or screw through the screw passage channel is therefore entirely avoided. Moreover, this preassembly prevents loss of the screw, which could either fall down or even more seriously be swallowed by the patient, thereby contributing considerably to the safety of the treatment.

In another preferred embodiment of the invention, the screw is furnished with a screwed screw bush.

The abutment can hence be furnished with the screw, which is fed through the axial screw passage channel of the abutment, and be screwed to the screw bush on the implant. The screw engages, by way of the coronally arranged screw head, in the inside of the abutment. This arrangement enlarges the apical end of the screw in the screwed condition. This arrangement is provided by the dental laboratory preassembled, so that during insertion, only the screw bush must be screwed, by way of its apically arranged outer thread, into the thread of the implant. This arrangement, on the one hand, enables simple insertion of the dental prosthesis and, on the other hand, loss of the screw is virtually precluded.

### BRIEF DESCRIPTION OF THE DRAWINGS

Further features and advantages of the present invention and the manner of action of the exemplary embodiments of the present invention are described hereinafter with reference to the accompanying drawings.

The accompanying drawings illustrate the present invention and further serve together with the description to explain the basic principles of the invention and to enable a person skilled in the art to manufacture and use the invention. In the drawings:

FIG. 1 shows a longitudinal section through an assembly of an abutment with a dental implant with a two-part screw according to a first embodiment of the invention;

FIG. 2 shows a side view of a screw rod of the two-part screw for a dental implant according to FIG. 1;

FIG. 3A shows a bottom view of a nut for the two-part screw for a dental implant from the side facing towards the dental implant, according to FIG. 1;

FIG. 3B shows a side view of a nut for the two-part screw for a dental implant according to FIG. 1;

FIG. 3C shows a plan view of a nut for the two-part screw for a dental implant from the side facing towards the abutment, according to FIG. 1;

FIG. 3D shows a longitudinal section of a nut for the two-part screw for a dental implant according to FIG. 1;

FIG. 4 shows a longitudinal section through an assembly of an abutment with a dental implant with a two-part screw according to a second embodiment of the invention;

FIG. 5A shows a plan view of a screw bush of the two-part screw of FIG. 4 in a view from a side facing towards the dental implant;

FIG. 5B shows a side view of the screw bush according to FIG. 4;

FIG. 5C shows a plan view of the screw bush according to FIG. 4 from a side facing towards the screw rod;

FIG. 5D shows a longitudinal section through the screw bush for the two-part screw according to FIG. 4;

FIG. 6A shows a side view of the screw rod according to FIG. 4;

FIG. 6B shows a plan view of the screw head of the second embodiment of the invention according to FIG. 4;

FIG. 6C shows a longitudinal section through the screw of the second embodiment of the invention according to FIG. 4.

### DESCRIPTION OF THE PREFERRED EMBODIMENTS

Based on the FIGS. 1 to 6C, two preferred embodiments of the present invention of a two-part screw for a dental implant are described, with a screw rod and a nut, which is formed with an inner thread for screwing connection to a thread on the screw rod, the screw rod being furnished with a further thread, or the screw bush having an outer thread, which is formed to screwingly connect the screw to the dental implant.

According to the invention, the screw rod can be selected narrower, while the diameter of the coronal and/or the apical end of the screw remains unchanged. This has the advantage that at the apical end of the abutment the wall thickness can be selected larger. By this means, this end is formed so as to be more stable, which is advantageous in particular when the material is ceramic.

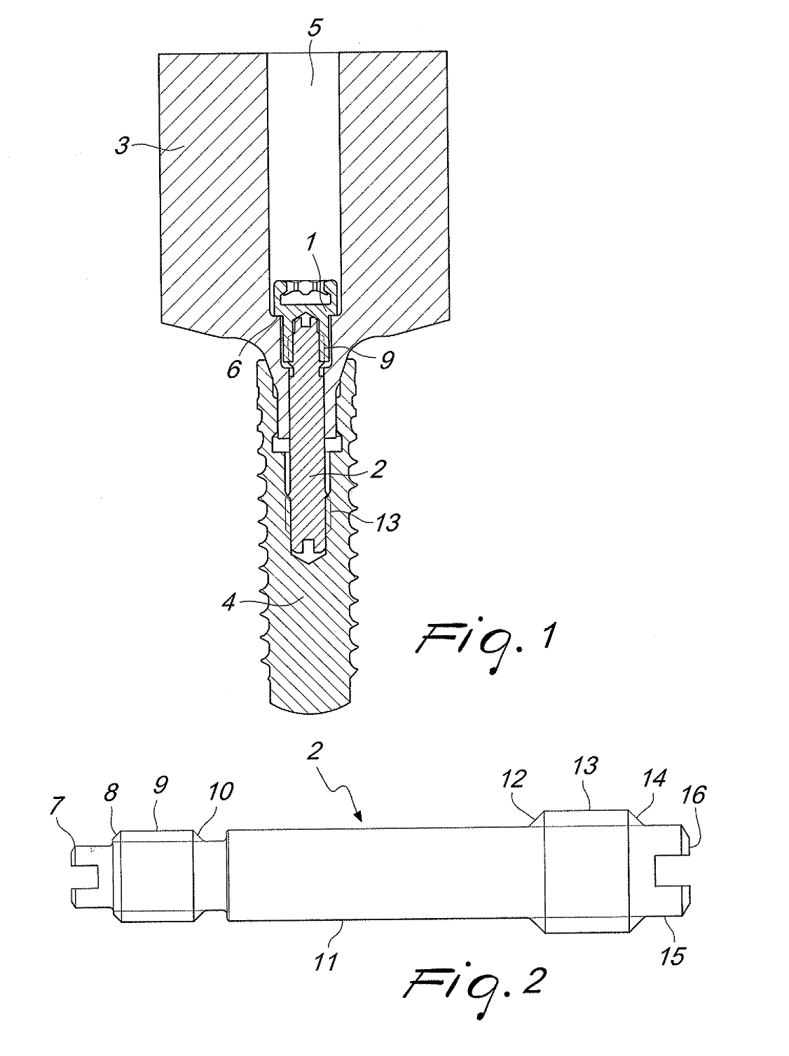

FIG. 1 shows a dental implant 4 with abutment 3 in the screwed condition, a two-part screw according to the first embodiment of the invention being employed therefore. In particular, the dental implant 4 and the abutment 3 are connected to one another by way of a two-part screw which comprises the nut 1 and the screw rod 2. For this, the nut 1 is screwed through a screw passage channel or screw passage chimney 5, which is arranged centrally in the abutment 3, onto a first thread 9 on the screw rod 2 (see FIG. 2), and tightened, the nut 1, in the filly tightened condition, bearing by way of an apically situated edge 6 on a step-shaped projection of the screw passage channel 5 of the abutment 3. The first thread 9 is, in the assembled condition, arranged at a coronal end of the screw. Tightening the screw to a torque of more than 30 Nm has proved particularly advantageous.

FIG. 2 shows that, on the screw rod 2, at the side facing towards the nut 1, a first symmetrical U-shaped pin 7 is formed, the lower edge of which is adjoined by a first chamfer 8, which, at the end of the screw rod 2, transitions into the coronally arranged first thread 9. The first chamfer 8 enables simple placing of the nut 1 on the screw rod 2 and prevents tilting thereof. Arranged adjoiningly thereto is an annular groove 10, which, in the axial direction, transitions into a cylindrical shaft 11. At the end of the cylindrical shaft 11 facing away from the first thread 9 a second chamfer 12 is located, which transitions seamlessly at the other end into a region of a second apically arranged thread 13. The threads 9 and 13 of the screw rod 2 are formed as outer threads. At the end of the second thread 13 a third chamfer 14 is arranged, which transitions into a second symmetrical U-shaped pin 16, the legs 15 of which are arranged flat in the axial direction and are in alignment with the outer diameter of the first thread 9.

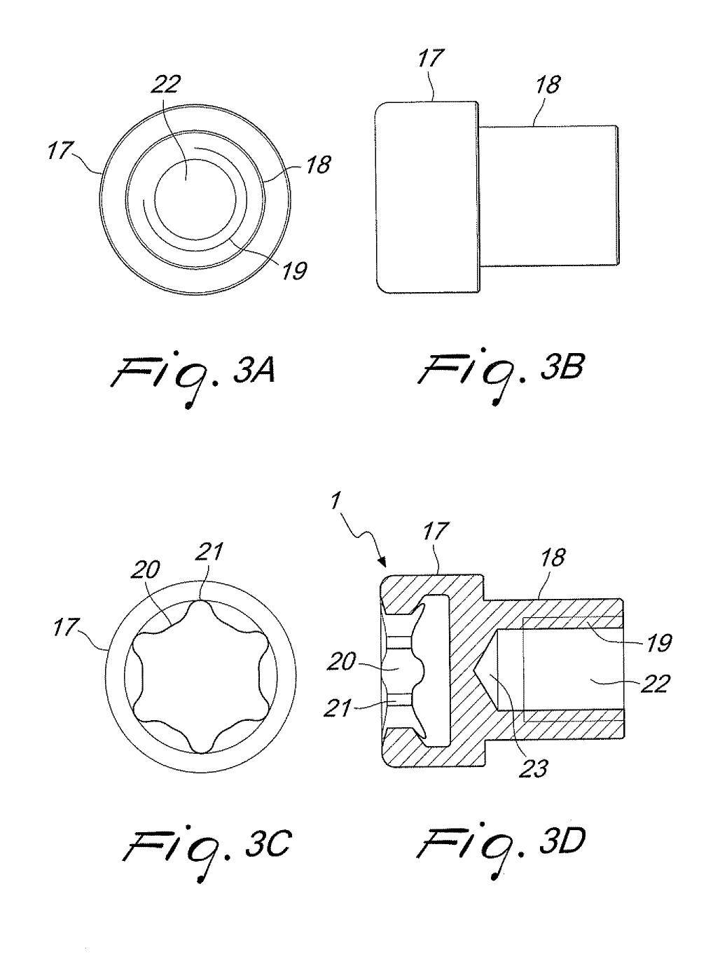

FIGS. 3A-3D show the nut 1 of the two-part screw according to the first embodiment of the present invention in different views. The nut 1 comprises a head 17 and a shaft 18 adjoining thereto. The head 17 is preferably shaped as an oval head and has, for receiving an insertion tool, which is not shown, an inner profile, which has the shape of a rounded, star-shaped inner hexagon (see FIG. 3C). The inner profile comprises, over the entire periphery, alternately the bulges 20 and the surfaces 21 lying therebetween. Similar profiles are also known as so-called Torx screws. In the shaft 18 a symmetrical blind hole 22 is arranged, which is provided with an inner thread 19 (third thread). The closed end of the blind hole 22 further has a conical depression 23. In the assembly condition, i.e. when the nut 1, engaging in the inside of the abutment 3, is screwed, by way of its inner thread 19 (third thread), through the screw passage channel 5 onto the corresponding first coronally arranged thread 9 of the screw rod 2, the nut 1 acts as a screw head for the combination of nut 1 and screw rod 2. The second thread 13 of the screw rod 2 is arranged at an apical end of the screw, which is axially enlarged in relation to the screw passage channel 5 of the abutment 3.

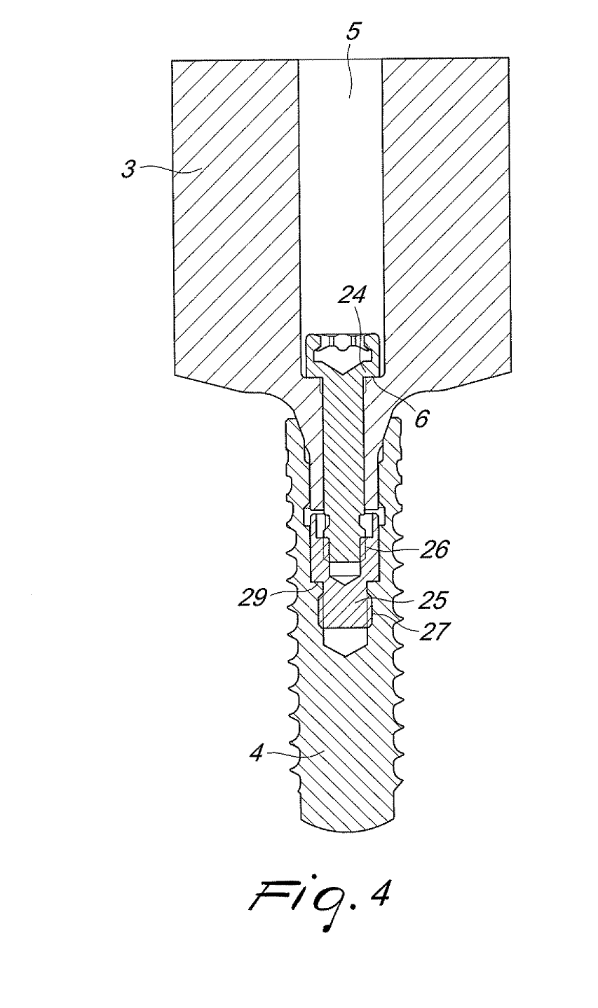

FIG. 4 shows a second embodiment of the two-part screw according to the invention, like elements as in FIG. 1 being designated with like reference numerals, and the dental implant 4 and the abutment 3 being connected by way of the two-part screw of the second embodiment, which is formed by a screw 24 and a screw bush 25.

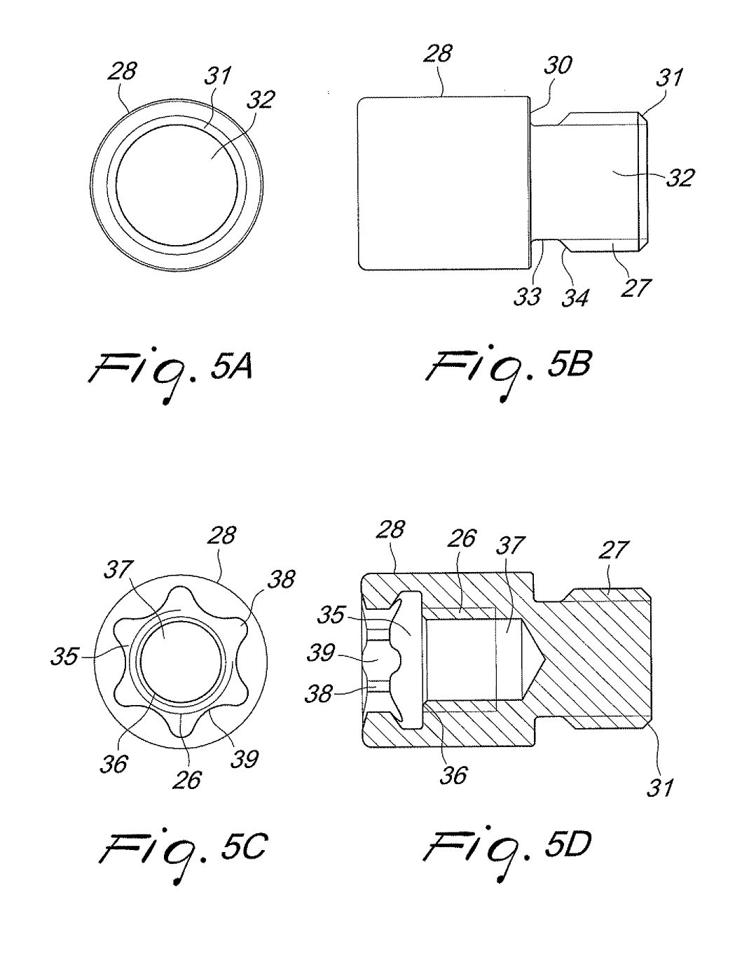

FIGS. 5A-5C show the screw bush 25 of the screw 24 of the second embodiment in different views, the screw bush 25 having a cylindrical head 28, which at one end adjoins, via a shoulder 30, a cylindrical portion 33, the shoulder 30 of the screw bush 25, in a position screwed to the abutment 3, bearing in a form-fitting manner on the edge 29 of the dental implant 4 (see FIG. 4).

The cylindrical portion 33 is adjoined by a second bevel 34, which, in the axial direction, abuts a first apical thread 27. The first apical thread 27 is formed as an outer thread over the entire periphery of the cylindrical pin 32 and has at the edge a first bevel 31, which abuts the first thread 27. The cylindrical head 28 has a symmetrical second bore 37, which projects in as far as the central region of the cylindrical portion 33, the region of a first bore 35 having a larger diameter than the second bore 37 and containing a star-shaped rounded inner hexagon. The inner hexagon comprises a plurality of bulges 39 and surfaces 38, which form rounded peaks. At the lower end of the bore 35 a chamfer 36 is located, which abuts a second coronal thread 26, which essentially encloses the second bore 37 in the axial direction, the second coronal thread 26 being formed as an inner thread. Although, in FIG. 5D, the outer diameter of the first apical thread 27 is shown smaller than the diameter of the cylindrical head 28, the outer diameter of the first apical thread 27 can be the same as the diameter of the cylindrical head 28, so that the entire part can be formed from a cylindrical block.

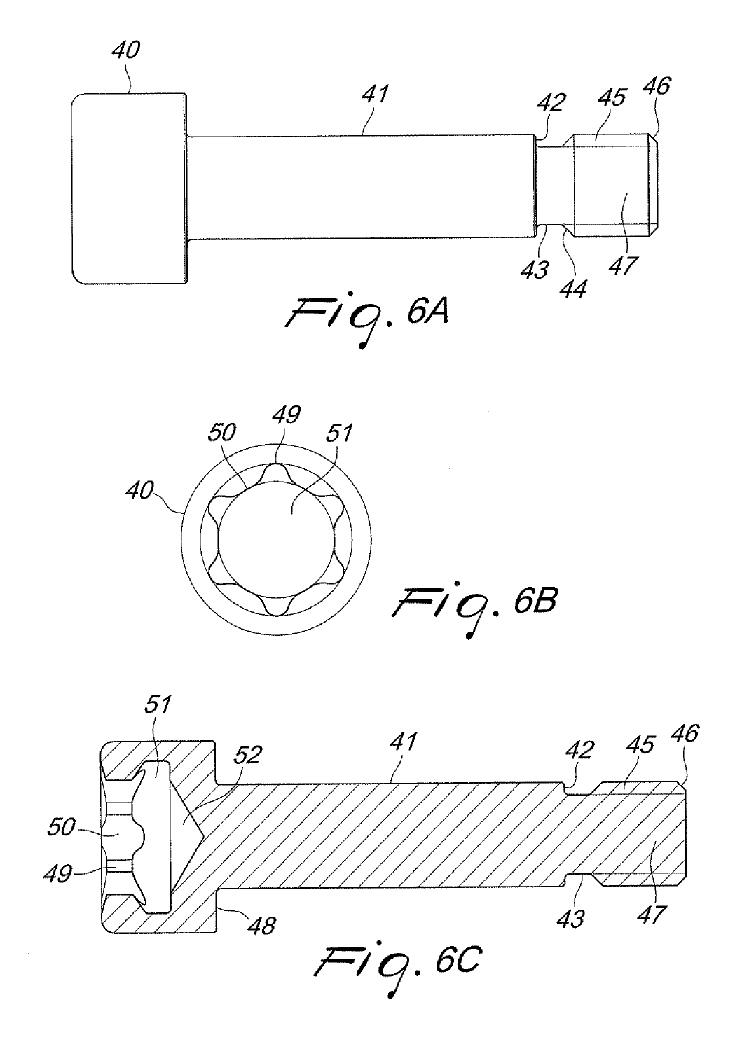

FIGS. 6A-6C show the screw 24 in different views. The screw 24 comprises a head 40, which is preferably formed as an oval head, a shaft 41 abutting thereon, which extends axially as far as a first bevel 42. The first bevel 42 is adjoined by a collar 43, which lies between a cylinder portion 47 and the shaft 41 and has a smaller diameter than shaft 41 and cylinder portion 47. The round-symmetrical cylinder portion 47 has a second bevel 44, which abuts the collar 43, and a third bevel 46, which, on the one hand, terminates the cylinder portion and, on the other hand, abuts an outer thread 45 (third thread), which is located between the two bevels 44, 46 and is formed as an outer thread. The thread root of the outer thread 45 substantially corresponds to the diameter of the collar 43.

The head 40 of the screw 24 has a star-shaped, rounded inner hexagon similar to that already described in FIGS. 3C and 5C, which has a plurality of surfaces 49 and bulges 50, which are arranged alternately over the entire periphery. On the bottom surface of the cavity 51 a conical depression 52 is located. In the screwed installation position, the edge 48 of the head 40 bears in a frictional and form-fitting manner on the edge 6 of the screw passage channel 5 of the abutment 3 (see FIG. 4).

Although the invention has been described in connection with the presently preferred embodiments, it will be immediately understandable to a person skilled in the art that modifications to the invention are possible without departing from the scope of protection of the appended claims. Thus, in the second embodiment, for example, the second thread 26 can be formed as an outer thread, and the third thread 45 as an inner thread.

The disclosures in EPA No. 07104421.8 from which this application claims priority are incorporated herein by reference.

What is claimed is:

1. A two-part screw for a dental implant with a screw rod and a nut, the nut being sized so as to be received into a screw passage channel of an abutment in an axially secured manner, and the nut being formed with an inner thread for screwing connection to a first coronal thread on the screw rod, the screw rod being furnished with a second apical thread, the second apical thread being formed to screwingly connect the screw to the dental implant,
wherein the end of the screw on which the second apical thread is formed has a diameter which is enlarged in relation to the diameter of an apical end of the screw passage channel of the abutment.

2. The two-part screw for a dental implant according to claim 1, wherein the nut acts, in the screwed condition, as a screw head, which is formed to bear, in a fully tightened condition of the screw, by way of an apically situated edge, on a step-shaped projection of the screw passage channel of the abutment.

3. The two-part screw according to claim 1, wherein the nut has a head, which has a rounded, star-shaped inner hexagon.

4. The two-part screw according to claim 2, wherein the nut has a head, which has a rounded, star-shaped inner hexagon.

5. A two-part screw for a dental implant with a screw and a screw bush, wherein the head of the screw is sized so as to be received into a screw passage channel of an abutment in an axially secured manner, and wherein the screw is provided apically with a third thread for screwing connection to a second coronal thread on the screw bush, the screw bush being furnished with a first apical thread, which is formed to screwingly connect the screw bush to the dental implant,

6. The two-part screw for a dental implant according to claim 5, wherein the screw bush has a diameter which is enlarged in relation to the diameter of an apical end of the screw passage channel of the abutment.

7. The two-part screw for a dental implant according to claim 5, wherein the head of the screw is formed to bear, in a fully tightened condition of the screw, by way of an apically situated edge, on a step-shaped projection of the screw passage channel of the abutment.

8. The two-part screw for a dental implant according to claim 5, wherein the first apical thread is formed as an outer thread, the second coronal thread is formed as an outer thread, and the third thread is formed as an inner thread.

9. The two-part screw for a dental implant according to claim 5, wherein the first apical thread is formed as an outer thread, the second coronal thread is formed as an inner thread, and the third thread is formed as an outer thread.

10. The two-part screw for a dental implant according to claim 6, wherein the first apical thread is formed as an outer thread, the second coronal thread is formed as an outer thread, and the third thread is formed as an inner thread.

11. The two-part screw for a dental implant according to claim 6, wherein the first apical thread is formed as an outer thread, the second coronal thread is formed as an inner thread, and the third thread is formed as an outer thread.

12. The two-part screw according to claim 5, wherein the head of the screw has a rounded, star-shaped inner hexagon.
